(19) United States
(12) Patent Application Publication
(10) Pub. No.: US 2006/0032080 A1
(43) Pub. Date: Feb. 16, 2006

(54) Device for spin drying a wiping body

(75) Inventors: Hendrik Rust, Remshalden-Hebsack (DE); Yunus Demirtas, Kornwestheim (DE); Ronald Schwarz, Winnenden (DE)

Correspondence Address: Lipsitz & McAllister, LLC, 755 MAIN STREET, MONROE, CT, 06468, US

(73) Assignee: Alfred Kaercher GmbH & Co. KG, Winnenden (DE)

(21) Appl. No.: 11/223,759

(22) Filed: Sep. 9, 2005

Related U.S. Application Data
(63) Continuation of application No. PCT/EP04/02319, filed on Mar. 6, 2004.

(30) Foreign Application Priority Data
Mar. 12, 2003 (DE) 103 11 813

(51) Int. Cl. F26B 21/00; F26B 13/10; F26B 19/00; F26B 11/02; D06F 58/00

(52) U.S. Cl. 34/524; 34/89; 34/108

(57) ABSTRACT

The invention relates to a device for spinning liquid out of a wiping body, which is mounted on a wiping head of a surface cleaning device, comprising a container, in which a wiping head mount is mounted rotatably, into which mount the wiping head can be inserted together with the wiping body and which can be driven rotationally about an axis of rotation by means of a drive device in order to remove moisture from the wiping body. In order to further develop the device in such a manner that its power consumption can be kept to a low level, it is proposed according to the invention that the device comprises a measuring element for determining a degree of drying or a spin drying time of the wiping body, there being associated with the measuring element an indicating unit for indicating when a specific degree of drying has been reached or a specific spin drying time has elapsed.

This application is a continuation of international application number PCT/EP2004/002319 filed on Mar. 6, 2004.

The present disclosure relates to the subject matter disclosed in international application number PCT/EP2004/002319 of Mar. 6, 2004 and German application number 103 11 813.6 of Mar. 12, 2003, which are incorporated herein by reference in their entirety and for all purposes.

### BACKGROUND OF THE INVENTION

The invention relates to a device for spinning liquid out of a wiping body, which is mounted on a wiping head of a surface cleaning device, comprising a container, in which a wiping head mount is mounted rotatably, into which mount the wiping head can be inserted together with the wiping body and which can be driven rotationally about an axis of rotation by means of a drive device in order to remove moisture from the wiping body.

In order to clean a dirty surface, in particular a floor surface, use is frequently made of a wiping body, for example a wiping mop, a wiping pad or a wiping cloth mounted on a wiping head forming a wiping surface. To clean the surface, the wiping head is moved together with the wiping body along the surface to be cleaned, so that dirt can be picked up. The wiping body, which is mounted on the wiping head, can then be rinsed and wrung out.

To wring it out, it is proposed, in WO 92/14394 A, to place the wiping head onto a wiping head mount which is subsequently caused to rotate, so that liquid is spun out of the wiping body because of the centrifugal forces in effect. This has the advantage that the user does not have to come into contact with the cleaning liquid. In the case of the device described in WO 92/14394 A, the wiping head mount is disposed in a first container which can be positioned above a collecting container in which the liquid spun out of the wiping body can be collected. In addition, a further container is provided, in which the wiping head, which is mounted on the wiping body, can be rinsed out.

From U.S. Pat. No. 4,506,403, there is known a device of the type mentioned at the beginning, in which a multipart container is used, having a first container part, which has a spin dryer region for spinning liquid out of the wiping body, and having a second container part, which surrounds a rinsing region for rinsing out the wiping body. If the wiping head with the wiping body mounted on it is introduced into the spin dryer region, then an electric motor of the drive device is automatically activated and, as a result, the wiping head mount together with the wiping head and the wiping body disposed on it is caused to rotate. For the supply of power, the known device can be connected via a connecting cable to a mains voltage. However, it may also be provided that the drive unit has a rechargeable battery which allows drive of the device independently of the mains. It is desirable for this purpose if the drive device consumes as little power as possible to spin dry the wiping body.

It is the object of the present invention to further develop a device of the type mentioned at the beginning in such a manner that the power consumption of the device can be kept to a low level.

### SUMMARY OF THE INVENTION

This object is achieved according to the invention in the case of a device of the generic type by the device comprising a measuring element for determining a degree of drying or a spin drying time of the wiping body, there being associated with the measuring element an indicating unit for indicating when a specific degree of drying has been reached or a specific spin drying time has elapsed.

The invention also incorporates the idea that the power consumption of the device can be kept to a low level by the user, during the spin drying of the wiping body, being signaled when a specific degree of drying has been reached or a specific spin drying time has elapsed. It can thereby be ensured in a structurally simple manner that the drive unit is not operated by the user for an unnecessarily long period of time but rather only for the time required to reach a specific degree of drying of the wiping body or for a specific spin drying time. This is so because it has been demonstrated that the user in many cases underestimates the spin drying effect and causes the wiping head mount to rotate together with the inserted wiping head and the wiping body for a relatively long time period without the degree of drying appropriate for cleaning a surface being further significantly improved.

The measuring element may be configured, for example, in the form of a sensor unit which detects the quantity of liquid spun out and, when a specific quantity of liquid and therefore a specific degree of drying is present, causes the indicating unit to indicate the degree of drying. It may alternatively be provided that the measuring element is configured in the form of a timing element coupled to the drive unit. This makes it possible to use the measuring element to detect the spin drying time of the wiping head mount and of the wiping head inserted therein and to activate the indicating unit after a specific spin drying time has elapsed.

It is advantageous if the indicating unit has at least one optical indicating element, for example a light emitting diode.

As an alternative or in addition, it may be provided that the indicating unit has an acoustic indicating element, for example a buzzer.

The indicating unit preferably comprises a plurality of indicating elements in each case indicating when a specific degree of drying has been reached or a specific spin drying time has elapsed. The longer the wiping head together with the wiping body mounted on it is caused to rotate, the more the degree of drying of the wiping body increases. If use is made of a plurality of indicating elements which correspond in each case to a specific degree of drying or a specific spin drying time, a user thereby obtains the option of waiting for the particular indicating signal after a desired degree of drying or after a desired spin drying time. When the desired indicating signal occurs, the user can then end the spin drying process.

Particularly simple handling and a particularly low level of consumption of power by the device can be obtained by the fact that the drive device can be switched off automatically when a specific degree of drying has been reached or after a specific spin drying time has elapsed.

It is advantageous if the desired degree of drying or the desired spin drying time can be predetermined by means of a setting element. The user can use the setting element to predetermine the spin drying time which he desires or the corresponding degree of drying. When this degree of drying has been reached or the corresponding spin drying time has elapsed, the indicating unit then signals the desired end of the spin drying process, so that the user can end the spin drying process himself or else the drive device switches off automatically.

It is advantageous in this case if the desired degree of drying or the desired spin drying time can be set in an infinitely variable manner by the user.

In order to ensure that the spin drying process only takes place when it is intended by the user, in the case of a preferred embodiment the drive device is coupled to a control element which is actuable by the user and is disposed on the container. As a result, the user has the option of inserting the wiping head together with the wiping body into the wiping mount in order then to set the spin drying process into operation consciously by actuation of the control element while the insertion of the wiping head into the wiping head mount in itself does not result in the drive device being activated. A configuration of this type also has the advantage that the user can position the wiping head within the wiping head mount after a surface has been cleaned, without the drive device being set into operation.

Particularly simple handling of the device can be obtained by the control element comprising a foot switch.

In a preferred embodiment of the invention, the container comprises a spin dryer region and a rinsing region, the rotatable wiping head mount being mounted in the spin dryer region and the rinsing region accommodating a cleaning liquid for rinsing out the wiping body, and the indicating element and/or the control element being disposed below the rinsing region. In the case of a configuration of this type, the user can first of all rinse out the wiping body in the rinsing region and can subsequently insert the wiping head into the wiping head mount and cause it to rotate, so that moisture is removed from the wiping body mounted on the wiping head. The end of the spin drying process is indicated to the user by means of the indicating unit which may be disposed below the rinsing region. As an alternative or in addition, it may be provided that the control element is disposed below the rinsing region. It has been demonstrated that this permits a particularly compact configuration of the device, with the indicating unit being easily accessible to the user and the control element being able to be actuated comfortably.

A particularly thorough cleaning of the wiping body in the rinsing region can be obtained by the fact that the rinsing region has a bottom wall which is oriented obliquely with respect to the axis of rotation of the wiping head mount and therefore, in the position of use of the device, obliquely with respect to the vertical and forms a rinsing plate with a friction surface which faces the interior of the container and against which the wiping body can be placed in a planar manner and along which the wiping body can be moved. In the form of the rinsing plate, the bottom wall forms a kind of washboard which permits reliable cleaning of the wiping body by the wiping body being movable to and fro thereon. In the position of use of the device, the bottom wall in this case is oriented obliquely with respect to the vertical and permits simple handling of the device, since the wiping body can be displaced, for example, from top to bottom along the obliquely oriented friction surface.

It is advantageous in this case if the control element and/or the indicating unit are disposed below the bottom wall. In this case, the bottom wall can cover a free space of the container which, for example, accommodates the control element and, in the case of a particularly preferred embodiment, also accommodates the indicating unit.

It is of particular advantage if the wiping body is mounted on the wiping head so as to form a wiping surface, and if the wiping head mount forms a receptacle into which the wiping head can be inserted with the surface normal of the wiping surface oriented obliquely or perpendicularly with respect to the axis of rotation of the wiping head mount. In the case of a configuration of this type, the wiping body is oriented during the spin drying in such a manner that the surface normal of the wiping surface does not take up a position parallel to the axis of rotation of the wiping head mount, but rather the surface normal is oriented at an angle with respect to the axis of rotation. It has been demonstrated that such an orientation of the wiping surface allows droplets of liquid to be spun out particularly effectively. As a result, a particularly high level of efficiency can be obtained. This makes it possible for moisture to be effectively removed from the wiping body within a short time even at relatively low speeds of rotation, so that a comparatively low consumption of power is required in order to remove moisture from the wiping body.

It has proven particularly advantageous if the receptacle receives the wiping head with the surface normal of the wiping surface oriented perpendicularly with respect to the axis of rotation. This permits a particularly compact configuration of the device. In addition, in a construction of this type, moisture can advantageously be removed from plate-like wiping bodies which form a wiping surface both on their upper side and on their lower side and consequently can be used on both sides. Wiping bodies of this type are usually mounted on a wiping head to which a shank or hand-grip is laterally hinged.

The wiping head with the wiping body mounted thereon can be pivoted relative to the shank or hand-grip in such a manner that either the upper side or the lower side of the wiping body faces the surface to be cleaned. This pivotable mounting of the wiping head on the shank or hand-grip simplifies the insertion of the wiping head with the wiping body mounted on it into the receptacle of the wiping head mount in such a manner that the surface normal of the wiping surface is oriented perpendicularly with respect to the axis of rotation of the wiping head mount.

It is advantageous if the container is configured in the manner of a bucket. It is advantageous if in this case the container comprises a basic body which is formed in one piece, surrounds the spin dryer region and the rinsing region and has a recessed formation which can be covered by means of a covering and defines a drive compartment which accommodates the drive device. In the case of an embodiment of particularly compact construction, provision is made here for the drive compartment to be disposed below the spin dryer region and for the rinsing region to extend laterally next to the spin dryer region and the drive compartment, it forming an insertion portion level with the spin dryer region and a liquid-accommodating region, which accommodates the cleaning liquid, level with the drive compartment. In this case, the liquid-accommodating region can extend underneath below the spin dryer region and, as a result, can have a comparatively large holding capacity for cleaning liquid in spite of the container being relatively small.

The description below of a preferred embodiment of the invention serves for more detailed explanation in conjunction with the drawing.

### BRIEF DESCRIPTION OF THE DRAWINGS

FIG. 1 shows a diagrammatic illustration of a floor wiping device with a wiping body mounted on a wiping head;

FIG. 2 shows a diagrammatic illustration of a device according to the invention for rinsing out and spin drying the wiping body, which is mounted on the wiping head of the floor wiping device, obliquely from above;

FIG. 3 shows a sectional view on the line 3-3 in FIG. 4;

FIG. 4 shows a simplified plan view of the device according to FIG. 2;

FIG. 5 shows a sectional view on the line 5-5 in FIG. 3, and

FIG. 6 shows a diagrammatic illustration of the device according to the invention obliquely from below.

### DETAILED DESCRIPTION OF THE INVENTION

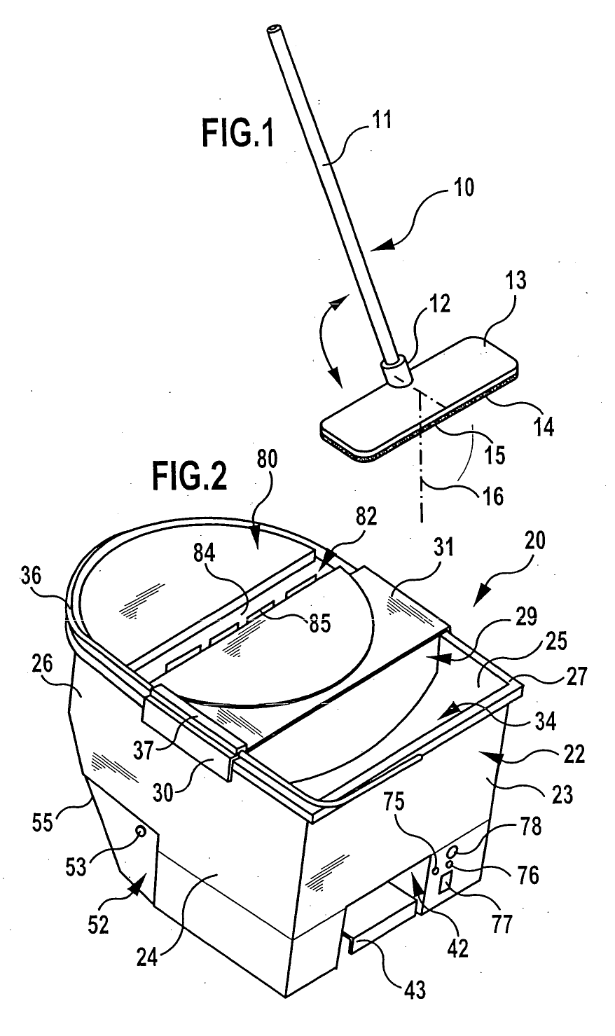

FIG. 1 illustrates, in diagrammatic illustration, a surface cleaning device in the form of a floor wiping device 10, which is known per se, with a shank 11 which is connected via a pivot 12 (illustrated in simplified form) to a wiping head 13 on the lower side of which, which faces away from the shank 11, a wiping body 14 of sheet-like configuration is fixed. The latter may be, for example, a wiping cloth which can be separated from the wiping head 13. The lower side of the wiping body 14, which faces away from the wiping head 13, forms a wiping surface 15 which, in order to pick up dirt, can be moved along a floor surface which is to be cleaned and the orientation of which is predetermined by a surface normal 16 oriented perpendicularly with respect to the wiping surface 15.

Floor surfaces can be cleaned in a customary manner by means of the floor wiping device 10. For this purpose, the wiping body 14 is moistened and is subsequently moved along the floor surface to be cleaned, so that, for example, dust can be picked up from the floor surface. The wiping body 14 is then rinsed out and wrung out, so that it only has a small degree of moisture left.

In order to rinse out and remove moisture from the wiping body 14, the invention uses the device which is illustrated in FIGS. 2 to 6 and is covered as a whole by the reference numeral 20 to rinse out and spin dry liquid from the wiping body 14. The device comprises a container in the form of a bucket 22 which has a flat transverse wall 23 which is connected integrally to longitudinal walls 24 and 25, which are oriented at a right angle to the transverse wall 23 and are disposed parallel to each other. The said longitudinal walls are connected integrally to each other on their side facing away from the transverse wall 23 via a curved wall 26, which is of semi-cylindrical configuration. On the upper side, the said walls 23 to 26 define an encircling upper edge 27 of the bucket 22.

A partition 29 which is curved in the shape of an arc of a circle is inserted into the bucket 22 and is engaged by retaining elements in the form of supporting wings 30, 31 approximately centrally over the upper edge 27 in the region of the longitudinal walls 24 and 25. The interior of the bucket 22 is divided into a spin dryer region 33 and a rinsing region 34 by means of the partition 29.

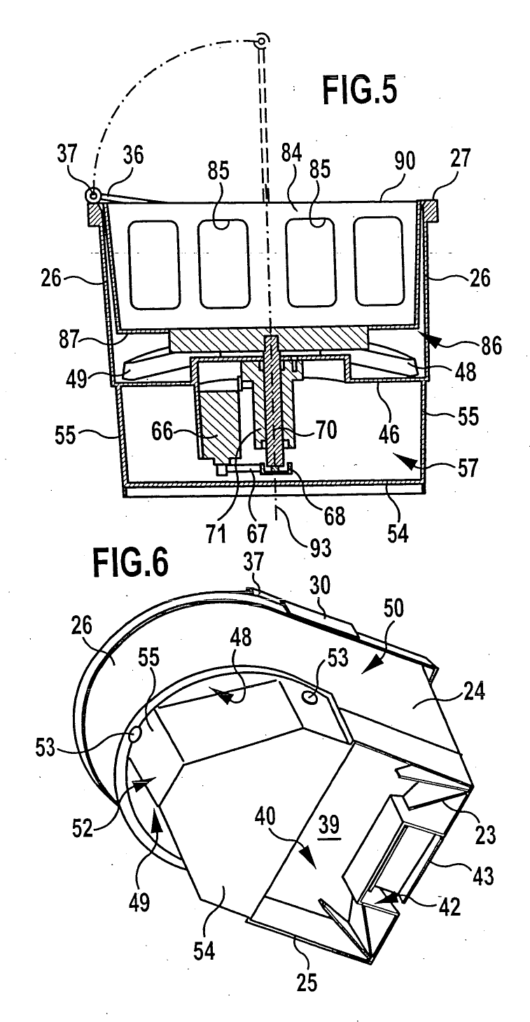

A carrying strap 36 on which a carrying handle 37 is centrally mounted is hinged, in each case centrally, to the upper edge 27 in the region of the transverse wall 23 and the curved wall 26. The carrying strap 36 spans the rinsing region 34 and the spin dryer region 33 in the longitudinal direction of the bucket 22 and can be pivoted between a position resting on the upper edge 27 and a pivoted-out position (illustrated by a dashed line in FIG. 5).

At a clear spacing from the partition 29, the transverse wall 23 and the longitudinal walls 24 and 25 are connected integrally to one another via a bottom wall 39 of the bucket 22, which bottom wall is inclined obliquely with respect to the vertical in the direction of the spin dryer region 34. The bottom wall 39 forms a rinsing or friction plate which will be discussed in more detail below. In this case, the transverse wall 23 projects downward beyond the bottom wall 39 in the same manner as the two longitudinal walls 24 and 25. In this projecting region, they define a free space 40 which is freely accessible from below. Beneath the bottom wall 39, the transverse wall 23 has a rectangular recessed formation 42 which extends into the free space 40 and in which a control element in the form of a foot switch 43 that is actuable by the user is disposed.

A stepped wall 45 which is oriented substantially parallel to the transverse wall 23 is molded onto that end of the bottom wall 39 which faces away from the transverse wall 23, the stepped wall extending approximately over half of the height of the bucket 22 and being integrally adjoined by a dividing wall 46 which is oriented substantially horizontally and via which the stepped wall 45 is connected to the curved wall 26. Two recessed grips 48, 49 which are accessible to the user are molded into the dividing wall 46 adjacent to the longitudinal walls 24 and 25.

The transverse wall 23 in combination with the two longitudinal walls 24, 25 and the curved wall 26 and also the bottom wall 39, the stepped wall 45 and the dividing wall 46 forms a basic body 50 which is of unitary configuration, is configured as a molded plastics part and, by means of the dividing wall 46 and the stepped wall 45, forms a recessed formation which is covered by a covering 52, which is of unitary configuration, can be connected releasably to the basic body 50 by means of connecting screws 53 and has a base plate 54 of substantially triangular configuration and a side wall 55 projecting upward vertically from the base plate 54 in the region of the curved wall 26. The side wall 55 here opens up to a user lateral access in each case to the recessed grips 48 and 49.

A drive compartment 57 of the bucket 22 is defined beneath the rinsing region 34 by the covering 52 along with the stepped wall 45 and the dividing wall 46.

On its upper side 59 facing the container interior, the bottom wall 39 carries a multiplicity of projections 60 which are of V-shaped configuration and are connected integrally to the bottom wall 39.

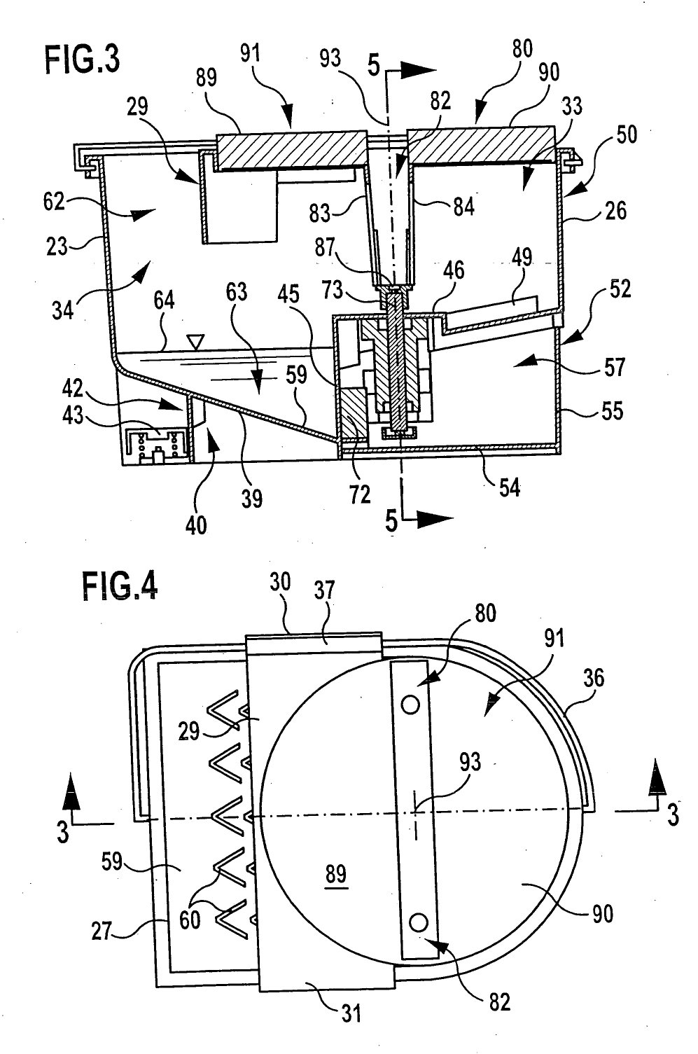

The rinsing region 34 forms an insertion section 62 level with the partition 29, and a liquid-accommodating region 63 which accommodates a cleaning liquid 64 is configured beneath the insertion section 62, in the region between the obliquely oriented bottom wall 39 and the vertically oriented stepped wall 45. This is clear in particular from FIG. 3.

The drive compartment 57 accommodates an electric motor 66 which is coupled via a pinion and a toothed belt 67 to a pulley 68 mounted in a rotationally fixed manner on a drive shaft 70. The said drive shaft is mounted via ball bearings on a bearing holder 71 fixed in the drive compartment 57 and reaches with its upper end region 73, which faces away from the pulley 68, through the dividing wall 46 and therefore enters into the rinsing region 33 of the bucket 22.

The drive compartment 57 accommodates in addition a rechargeable battery 72 for the power supply to the electric motor 66.

The electric motor 66 is electrically connected via electric connecting lines (not illustrated in the drawing) which are known per se to a control unit, which is known to the person skilled in the art and is therefore not illustrated in the drawing so as to obtain better clarity and is disposed within the drive compartment 57 or alternatively within the free space 40 and, for its part, is connected to the foot switch 43, and also to two optical indicating elements in the form of two light emitting diodes 75, 76, disposed on the transverse wall 23 next to the foot switch 43, and to an acoustic indicating element in the form of a buzzer 77 disposed on the transverse wall 23 below the light emitting diodes 75, 76. In addition, the control unit is electrically connected to an electric setting element, which is mounted on the transverse wall 23 above the light emitting diode 76 and is in the form of a selector switch 78.

The spin dryer region 23 accommodates a wiping head mount 80, which is of integral configuration in the form of a molded plastics part and has two side walls 83, 84 which are oriented parallel to each other and define a receptacle 82 between them and are configured in the manner of a cage with a multiplicity of passage openings 85. The side walls 83, 84 are connected integrally to each other via a substantially U-shaped supporting clip 86 which has a horizontally oriented cross-piece 87, which is reinforced in its central region, and is seated on the upper end region 73 of the drive shaft 70 via a positive connection.

The wiping head mount 80 also comprises a lid 91 comprising two lid halves 89 and 90. The two lid halves 89 and 90 are connected here integrally to a respective side wall 83 and 84 of the wiping head mount 80. The spin dryer region 33 of the bucket 22, with the exception of the receptacle 82 of the wiping head mount 80, is completely covered by means of the lid 91.

By means of the electric motor 66 via the drive shaft 70, the wiping head mount 80 can be caused to rotate about the longitudinal axis of the drive shaft 70, i.e. the longitudinal axis of the drive shaft 70 defines an axis of rotation 93 of the wiping head mount 80, which axis of rotation is oriented vertically in the position of use of the device 20.

For rinsing out purposes, the wiping head 13 with the wiping body 14 mounted thereon can be introduced through the insertion section 62 and dipped into the cleaning liquid 64 of the liquid-accommodating region 63. For this purpose, the wiping head 13 is pivoted with the aid of the pivot 12, starting from the operating position illustrated in FIG. 1, about a pivot axis oriented transversely with respect to the longitudinal axis of the shank 11 to an extent such that the surface normal 16 of the wiping surface 15 is oriented substantially perpendicularly with respect to the axis of rotation 93 of the wiping head mount 80. In this pivoted position, the wiping head 13 can be introduced via the insertion section 62 into the rinsing region 34 until the front end edge of the wiping head 13, which end edge faces away form the shank 11, strikes against the upper side 59 of the bottom wall 39. The wiping body 14 mounted on the wiping head 13 can subsequently be placed, by renewed pivoting of the wiping head 13, in a planar manner onto the upper side 59 of the bottom wall 39 and can then be moved along the upper side 59 in the direction of the stepped wall 45. A reliable cleaning of the wiping body 14 surrounded by the cleaning liquid 64 is obtained here by means of the projections 60 protruding from the upper side 59. The bottom wall 39 with projections 60 molded onto it therefore forms a rinsing or friction plate with the help of which wiping body 14 can be thoroughly rinsed out.

After cleaning has taken place, the wiping head 13 with the wiping body 14 mounted on it can be removed again via the insertion section 62 from the rinsing region 34 and can then be inserted into the receptacle 82 of the wiping head mount 80. The user can then set the electric motor 66 into operation by actuation of the foot switch 43, so that the entire wiping head mount 80 together with the wiping body 14 is caused to rotate via the drive shaft 70. Because of the rotational movement, the liquid held by the wiping body 14 experiences a centrifugal force, so that liquid is spun out of the wiping body 14 in the radial direction and strikes against the interior of the curved wall 26 and against that side of the partition 29 which faces the spin dryer region 23. The liquid which has been spun out subsequently flows downward along the said walls and collects again in the liquid-accommodating region 63.

By means of the light emitting diodes 75 and 76 and the buzzer 77, the user obtains feedback about the progress of the degree of drying of the wiping body 14 inserted into the receptacle 82. For this purpose, the control unit comprises a measuring element in the form of a timing element, which is known per se and is therefore not illustrated in the drawing, which measures the spin drying time, which is determined by the actuation of the foot switch 43, of the wiping head mount 80. The duration of the spin drying process, which takes place at a fixedly predetermined speed of rotation, corresponds in each case to a specific degree of drying of the wiping body. When a specific length of time has elapsed and therefore when a first degree of drying has been reached, the timing element first of all activates the light emitting diode 75, so that the latter illuminates, and, as the rotational movement continues, activates the light emitting diode 76 after a further length of time has elapsed and therefore when an advanced degree of drying has been reached, and the buzzer 77 sounds. The respectively desired degree of drying can be set in stepless manner by the user by means of the selector switch 78. The user can subsequently release the foot switch 43 again, so that the rotational movement of the wiping head mount 80 is ended and the wiping head 13 together with the wiping body 14 can consequently be removed from the wiping head mount 80. To pick up dirt, the wiping head together with the wiping body 14 can then be moved along the floor surface to be cleaned, in order then to be cleaned again in the rinsing region 34 of the device 20.

From the above it is clear that the device 20 has a compact form, with the rinsing region 34 extending beneath the spin dryer region 33 and the drive compartment 75 being disposed beneath the spin dryer region 33. The bottom wall 39 forms a rinsing or friction plate for the thorough cleaning of the wiping body 14, which can be placed in a planar manner onto the rinsing plate and can be moved along the latter, with the cleaning action being reinforced by the protruding projections 60. The use of the indicating elements in the form of the light emitting diodes 75 and 76 and the buzzer 77 considerably simplifies the handling of the device 20 according to the invention, since the user obtains feedback about the progress of the degree of drying, which he can predetermine by means of the selector switch 76. In addition, the energy consumption of the device 20 can be significantly reduced as a result, since the spin drying process can be ended immediately after a specific degree of drying is reached.

1. Device for spinning liquid out of a wiping body, which is mounted on a wiping head of a surface cleaning device, comprising a container, in which a wiping head mount is mounted rotatably, into which mount the wiping head can be inserted together with the wiping body and which can be driven rotationally about an axis of rotation by means of a drive device in order to remove moisture from the wiping body, wherein the device comprises a measuring element for determining a degree of drying or a spin drying time of the wiping body, there being associated with the measuring element an indicating unit for indicating when a specific degree of drying has been reached or a specific spin drying time has elapsed.

2. Device according to claim 1, wherein the measuring element is configured as a timing element coupled to the drive device.

3. Device according to claim 1, wherein the indicating unit has at least one optical indicating element.

4. Device according to claim 1, wherein the indicating unit has an acoustic indicating element.

5. Device according to claim 1, characterized in that the indicating unit has a plurality of indicating elements in each case indicating the reaching of a specific degree of drying or the elapse of a specific spin drying time.

6. Device according to claim 1, wherein the drive device can be switched off automatically when a specific degree of drying has been reached or after a specific spin drying time has elapsed.

7. Device according to claim 5, wherein the desired degree of drying or the desired spin drying time can be predetermined by means of a setting element.

8. Device according to claim 6, wherein the desired degree of drying or the desired spin drying time can be set in a stepless manner.

9. Device according to claim 1, wherein the drive device is coupled to a control element which is actuable by the user and is disposed on the container.

10. Device according to claim 8, wherein the control element comprises a foot switch.

11. Device according to claim 1, wherein the container comprises a spin dryer region and a rinsing region, the rotatable wiping head mount being disposed in the spin dryer region and the rinsing region accommodating a cleaning liquid for rinsing out the wiping body, the indicating unit and/or the switching element being disposed below the rinsing region.

12. Device according claim 1, wherein the container comprises a rinsing region which accommodates a cleaning liquid for rinsing out the wiping body and has a bottom wall which is oriented obliquely with respect to the axis of rotation of the wiping head mount and forms a rinsing plate with a friction surface which faces the interior of the container and against which the wiping body can be placed in a planar manner and along which the wiping body can be moved.

13. Device according to claim 12, wherein the indicating unit and/or the control element are disposed below the bottom wall.

14. Device according to claim 1, wherein the wiping body is mounted on the wiping head so as to form a wiping surface, and wherein the wiping head mount forms a receptacle into which the wiping head can be inserted with the surface normal of the wiping surface oriented obliquely or perpendicularly with respect to the axis of rotation of the wiping head mount.

15. Device according to claim 14, wherein the receptacle receives the wiping head with the surface normal of the wiping surface oriented perpendicularly with respect to the axis of rotation of the wiping head mount.
